(19) United States
(12) Patent Application Publication
(10) Pub. No.: US 2006/0170902 A1
(43) Pub. Date: Aug. 3, 2006

(54) Apparatus and method for a loading reticle

(76) Inventors: Yoo-Keun Won, Gyeonggi-do (KR); Young-Ho Park, Gyeonggi-do (KR); Kil-Jin Lee, Gyeonggi-do (KR)

Correspondence Address: MARGER JOHNSON & MCCOLLOM, P.C., 210 SW MORRISON STREET, SUITE 400, PORTLAND, OR, 97204, US

(21) Appl. No.: 11/344,422

(22) Filed: Jan. 30, 2006

(30) Foreign Application Priority Data
Feb. 3, 2005 (KR) 2005-10226

(51) Int. Cl. G03B 27/62

(52) U.S. Cl. 355/75

(57) ABSTRACT

An apparatus and method to load a reticle, to check whether the reticle is loaded in a flat manner and to flatten the reticle when the reticle is not loaded in a flat manner. In one embodiment, the apparatus includes a sensor to sense the degree of flatness of the reticle, and reticle support units to support the reticle in a flat manner. The reticle support units include cylinders that are disposed under, for example, at least both sides of the reticle and may be independently moveable to vertically move the reticle according to the degree of flatness of the reticle sensed by the sensor.

### BACKGROUND OF THE INVENTION

This application claims the priority of Korean Patent Application No. 10-2005-0010226, filed on Feb. 3, 2005, in the Korean Intellectual Property Office, the entire disclosure of which is incorporated herein by reference.

1. Field of the Invention

The present invention relates to an apparatus and method for manufacturing a semiconductor device, and more particularly, to an apparatus and method for loading a reticle in a flat manner.

2. Description of the Related Art

Manufacturing a semiconductor device generally includes an exposure process performed by placing a reticle, on which a circuit pattern is formed, on a semiconductor substrate coated with a photoresist, and exposing the reticle to light from a light source to transfer the circuit pattern to the semiconductor substrate. To perform the exposure process, the reticle is first loaded on a reticle stage.

FIG. 1 is a schematic view of a conventional system for loading a reticle.

Referring to FIG. 1, the conventional reticle loading system includes a reticle library 10 storing a plurality of reticles, and a reticle stage 20 on which a reticle is mounted. A pre-alignment unit 50 is installed between the reticle library 10 and the reticle stage 20. A transfer robot 40 is disposed between the reticle stage 20 and the pre-alignment unit 50 to transport the reticle. The transfer robot 40 includes a hand 41 for handling the reticle and an arm 42 for moving the hand 41. When one reticle selected from the plurality of reticles stored in the reticle library 10 is moved to the pre-alignment unit 50, the transfer robot 40 fetches the pre-aligned reticle and loads it on the reticle stage 20.

FIG. 2 is a perspective view of the conventional reticle loading system for explaining a procedure for loading a reticle 30 on the reticle stage 20.

Referring to FIG. 2, the reticle stage 20 includes reticle supports 22 on which the reticle 30 is loaded. The reticle supports 22 are typically made of a solid material such as quartz, and a vacuum hole 24 is formed in each of the reticle supports 22 to securely fix the reticle 30. The reticle 30 is loaded on top surfaces of the reticle supports 22 by the transfer robot 40. Thus, both sides of the reticle 30 come in contact with the reticle supports 22 and the reticle 30 is disposed parallel and aligned to a semiconductor substrate that is located under the reticle 30. When the reticle 30 is loaded on the reticle supports 22, the vacuum hole 24 is activated to attract and fix the reticle 30 in place.

The reticle 30, however, may fail to be loaded on the reticle supports 22 in a flat manner due to various reasons. For example, a central portion of the reticle 30 may be warped downward due to the weight of the reticle 30. Also, the reticle 30 may be inclined if foreign particles are present between a bottom surface of the reticle 30 and the reticle supports 22. A conventional system for detecting foreign particles detects only foreign particles on a pattern formed on the reticle 30 but not between the reticle supports 22 and the reticle 30. Additionally, non-uniform thickness of the reticle 30 caused during a manufacturing process may result in the deformation of the reticle exposed during an exposure process.

The conventional reticle loading system cannot check whether the reticle 30 is loaded on the reticle supports 22 in a flat manner. Moreover, when the reticle 30 is not loaded in a flat manner, the conventional reticle loading system cannot correct the problem and flatten the reticle 30.

### SUMMARY

Embodiments of the present invention provide an apparatus and a method for loading a reticle, which checks whether the reticle is loaded in a flat manner and flattens the reticle when the reticle is not loaded in a flat manner.

According to an embodiment of the present invention, an apparatus for loading a reticle, comprises: a sensor to sense the degree of flatness of the reticle; and a plurality of reticle support units to support the reticle in a flat manner, wherein the reticle support units include a plurality of cylinders that are disposed under the reticle and may vertically move the reticle according to the degree of flatness of the reticle sensed by the sensor.

The sensor may be a photodetector that processes an optical signal, and may determine the degree of flatness of the reticle by analyzing the intensity of an optical signal reflected from a top surface of the reticle according to the position of the reticle.

The apparatus may further comprise a control unit that is disposed between the sensor and the reticle support units and controls the movement of the reticle support units using the degree of flatness of the reticle sensed by the sensor.

According to another embodiment of the present invention, a method of loading a reticle, comprises: loading a reticle on a plurality of reticle support units; sensing the degree of flatness of the reticle using a sensor; and flattening the reticle using a plurality of cylinders of the reticle support units, wherein the plurality of cylinders are disposed under the reticle and are moved to vertically move the reticle according to the degree of planarization of the reticle sensed by the sensor.

The sensing of the degree of flatness of the reticle using the sensor may comprise: emitting an optical signal at a predetermined angle toward a top surface of the reticle using a light emitting unit; and sensing the optical signal reflected from the top surface of the reticle using a light receiving unit.

The flattening of the reticle may comprise: inputting the degree of flatness of the reticle sensed by the sensor to a control unit; and moving the cylinders of the reticle support units using a signal processed by the control unit.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view of a conventional system for loading a reticle;

FIG. 2 is a perspective view of the conventional reticle loading system of FIG. 1 for explaining a procedure for loading a reticle on a reticle stage;

FIG. 3 is a perspective view of an apparatus for loading a reticle according to an embodiment of the present invention;

FIG. 4 is a cross-sectional view of the apparatus of FIG. 3 for explaining a method of loading a reticle according to an embodiment of the present invention; and

FIG. 5 is a cross-sectional view of an apparatus for loading a reticle according to another embodiment of the present invention.

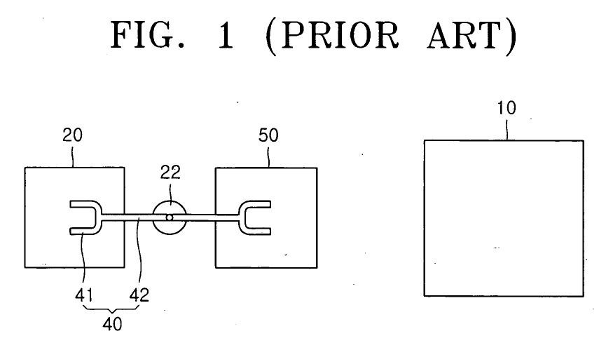

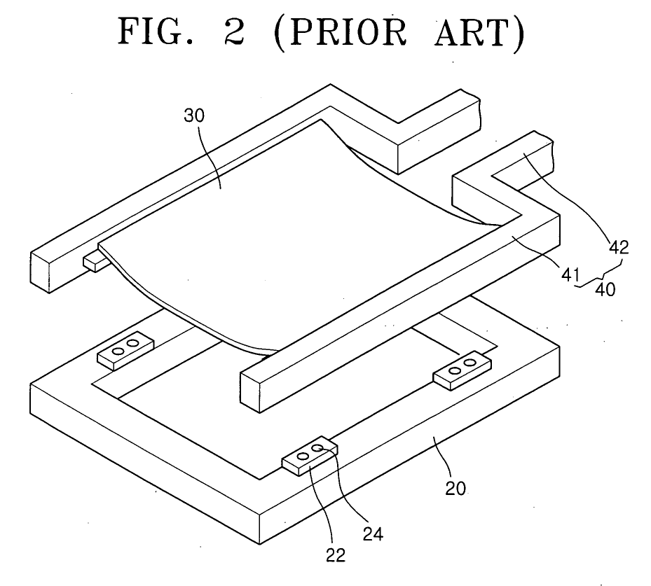

### DETAILED DESCRIPTION

The present invention will now be described more fully with reference to the accompanying drawings, in which preferred embodiments of the invention are shown.

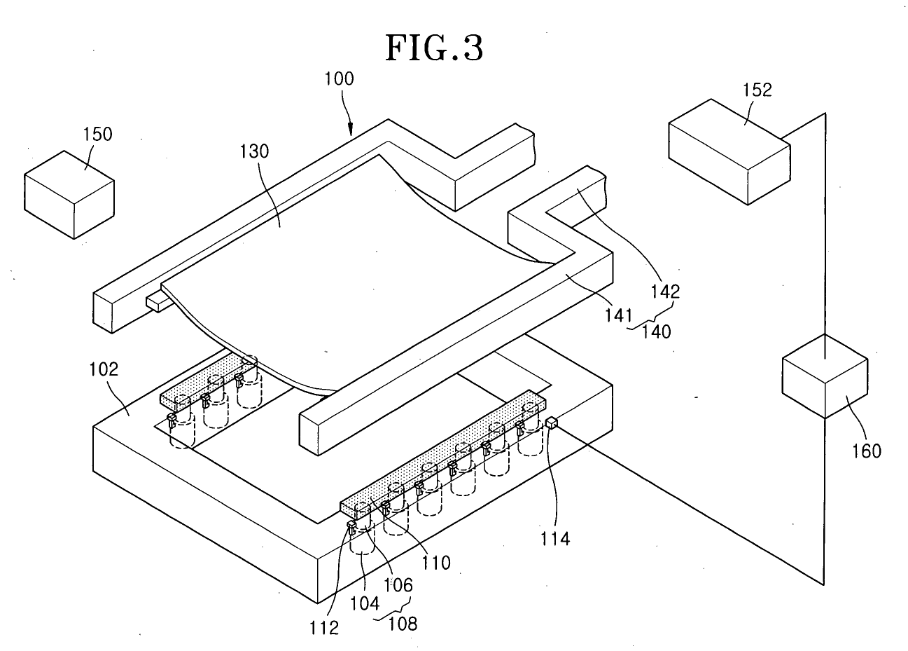

FIG. 3 is a perspective view of an apparatus for loading a reticle according to an embodiment of the present invention.

Referring to FIG. 3, the reticle loading apparatus includes a reticle loading portion 100 for loading a reticle 130, a first sensor for sensing the degree of flatness of the reticle 130, and a control unit 160 for electrically processing a signal sensed by the first sensor. Here, the first sensor includes a light emitting unit 150 and a light receiving unit 152.

The reticle loading portion 100 includes a reticle stage 102 on which the reticle 130 is loaded, and a transfer robot 140 that includes a hand 141 for handling the reticle 130 and an arm 142 for moving the hand 141. Specifically, the reticle 130 is loaded on first reticle support units 108 installed inside the reticle stage 102.

The first reticle support units 108 are disposed under both sides of the loaded reticle 130. The first reticle support units 108 include a plurality of cylinders 106, which may independently move to vertically move the reticle 130, and driving sources 104, for example, motors, which drive the cylinders 106. The reticle loading apparatus may further include a second sensor 112 that is disposed on a side of each cylinder 106 to sense the pressure applied to the cylinder 106 and the displacement of the cylinder 106. Top surfaces of the cylinders 106 may be substantially flat.

Pads 110 with an elastic force strong enough not to be separated from the top surfaces of the cylinders 106 even during the vertical movement of the cylinders 106 may be attached to the top surfaces of the cylinders 106. The pads 110 may be made of a flexible and elastic material, such as a polymer film.

The first sensor includes the light emitting unit 150 and the light receiving unit 152, which is a photodetector that processes an optical signal and senses the degree of flatness of the reticle 130. Specifically, the light emitting unit 150 emits an optical signal at a predetermined angle toward a top surface of the reticle 130. The optical signal is a plane wave with a predetermined width, which is emitted in one direction for sensing the degree of flatness between both ends of the reticle 130. The emitted optical signal is reflected from the top surface of the reticle 130 and is sensed by the light receiving unit 152. That is, the light receiving unit 152 senses the intensity of the optical signal reflected from the top surface of the reticle 130 according to the position of the reticle 130.

The control unit 160 can determine the degree of flatness of the reticle 130 by analyzing the intensity of the optical signal sensed by the light receiving unit 152. The control unit 160 controls the movement of the cylinders 106 of the first reticle support units 108 using information on the determined degree of flatness. The second sensor 112 measures the height of each of the cylinders 106 and a pressure applied to the cylinder 106. The second sensor 112 may be a magnetic sensor or a photodetector, for example. A control signal transmitted from the control unit 160 is input to an input/output terminal 114, and information on the height and pressure measured by the second sensor 112 is output from the input/output terminal 114.

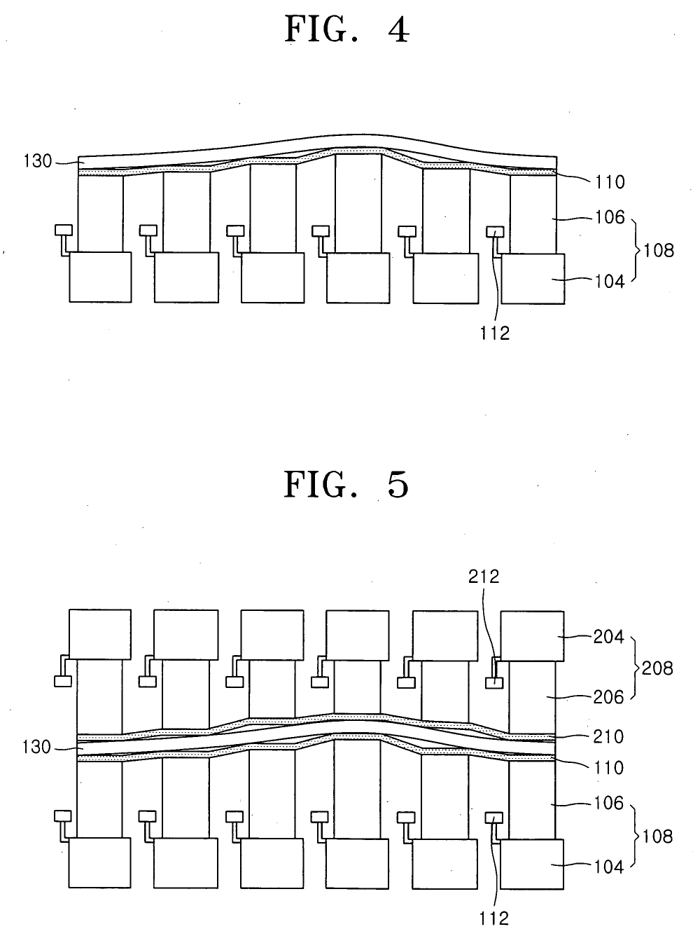

FIG. 4 is a cross-sectional view of the apparatus of FIG. 3 for explaining a method of loading a reticle according to an embodiment of the present invention.

Referring to FIG. 4, first, the reticle 130 is loaded on the first reticle support units 108. Thereafter, the first sensor including the light emitting unit 150 and the light receiving unit 152 senses the degree of flatness of the loaded reticle 130. The reticle 130 is flattened by the plurality of cylinders 106 of the first reticle support units 108 disposed under at least both sides of the reticle 130. The plurality of cylinders 106 may independently move to vertically move the reticle 130 according to the degree of flatness of the reticle sensed by the first sensor comprising the light emitting unit 150 and the light receiving unit 152.

That is, the cylinders 106 are vertically moved by the driving sources 104, which are driven by the control unit 160, according to the degree of flatness of the reticle 130. The pads 110 having an elastic force are attached to top surfaces of the cylinders 106 to relieve pressure applied to the reticle 130. Further, the pads 110 may be made of a viscous polymer resin so that they can hold and protect the reticle 130 from being separated from the first reticle support units 108 during an exposure process.

According to the reticle loading apparatus and the reticle loading method illustrated in FIGS. 3 and 4, reticle warpage, foreign particles, non-uniform thickness of the reticle, and so on are sensed before the exposure process and then the reticle is flattened according to the sensed results, thereby preventing the reticle transferred onto a semiconductor substrate from being deformed. Consequently, a poor pattern or poor overlay can be avoided.

FIG. 5 is a cross-sectional view of an apparatus for loading a reticle according to another embodiment of the present invention. Another method of loading a reticle will be also described with reference to the apparatus of FIG. 5.

Referring to FIG. 5, the reticle loading apparatus includes second reticle support units 208 disposed over the first reticle support units 108 to flatten together with the first reticle support units 108 the reticle 130 that is loaded on the first reticle support units 108. The second reticle support units 208 are disposed over at least both sides of the reticle 130 to face the first reticle support units 108 and the reticle 130, and include a plurality of cylinders 206 that may independently moved to vertically move the reticle 130 according to the degree of flatness of the reticle 130 sensed by the first sensor composed of the light emitting unit 150 and the light receiving unit 152.

Further, the second reticle support units 208 may further include driving sources 204, for example, motors, which drive the cylinders 206. The reticle loading apparatus of FIG. 5 may further include a plurality of second sensors 212 respectively disposed at a side of each of the cylinders 206 to sense a pressure applied to the cylinder 206 and the displacement of the cylinder 206. Bottom surfaces of the cylinders 206 may be flat. Pads 210 with a predetermined elastic force strong enough not to be separated from the bottom surfaces of the cylinders 206 even during the vertical movement of the cylinders 206 may be attached to the bottom surfaces of the cylinders 206. The pads 210 may be made of a flexible and elastic material, such as a polymer film.

According to the reticle loading method using the reticle loading apparatus of the present embodiment illustrated in FIG. 5, reticle warpage, foreign particles, a non-uniform thickness of the reticle, and so on are sensed before an exposure process and then the reticle is flattened according to the sensed results, thereby preventing the reticle transferred onto a semiconductor substrate from being deformed. Consequently, a poor pattern and poor overlay can be avoided. In addition, since the reticle is flattened using both the first reticle support units 108 and the second reticle support units 208, the reticle can be flattened more accurately.

According to the reticle loading apparatus and method of the embodiments of the present invention, the reticle can be flattened by the first reticle support units that may independently move.

Moreover, since the reticle loading apparatus and method use the sensor for checking the presence of foreign particles between the reticle support units and the reticle, the inclination of the reticle due to the foreign particles can be corrected and thus the reticle can be loaded on the reticle support units in a flat manner.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus to hold a reticle, comprising:
a first sensor to sense the degree of flatness of the reticle; and
first reticle support units to support the reticle in a flat manner,
wherein the first reticle support units include cylinders that are disposed under the reticle and are structured and arranged to move the reticle corresponding to the degree of flatness of the reticle sensed by the first sensor.

2. The apparatus of claim 1, wherein the first sensor is a photodetector that processes an optical signal.

3. The apparatus of claim 1, wherein the first sensor determines the degree of flatness of the reticle by analyzing the intensity of an optical signal reflected from a top surface of the reticle corresponding to the position of the reticle.

4. The apparatus of claim 1, wherein top surfaces of the cylinders are substantially flat.

5. The apparatus of claim 1, wherein the first reticle support units further include pads that are attached to top surfaces of the cylinders and have an elastic force strong enough not to be separated from the top surfaces of the cylinders during the movement of the cylinders.

6. The apparatus of claim 5, wherein the pads are polymer films.

7. The apparatus of claim 1, further comprising a control unit to control the movement of the first reticle support units using the degree of flatness of the reticle sensed by the first sensor.

8. The apparatus of claim 1, wherein the first reticle support units each include a driving source to drive the cylinders, respectively.

9. The apparatus of claim 1, further comprising second sensors, each disposed on a side of each of the cylinders to sense the movement of the cylinder.

10. The apparatus of claim 9, wherein the second sensor is adapted to sense information regarding the height of the cylinder and a pressure applied to the cylinder.

11. The apparatus of claim 1, further comprising second reticle support units that are disposed over the first reticle support units,
wherein the second reticle support units include second cylinders that are disposed over at least the both sides of the reticle to face the first reticle support units and the reticle and are independently moveable to vertically move the reticle corresponding to the degree of flatness of the reticle sensed by the first sensor.

12. The apparatus of claim 1, further comprising vacuum holes disposed in the cylinders to securely hold the reticle.

13. The apparatus of claim 1, wherein the cylinders are disposed under at least both sides of the reticle and are independently moveable to vertically move the reticle corresponding to the degree of flatness of the reticle sensed by the first sensor.

14. A method of loading a reticle, comprising:
loading a reticle on first reticle support units each having a cylinder;
sensing the degree of flatness of the reticle using a first sensor; and
flattening the reticle using the first reticle support units' cylinders, wherein the cylinders are disposed under the reticle and are adapted to move the reticle corresponding to the degree of flatness of the reticle sensed by the first sensor.

15. The method of claim 14, wherein the sensing of the degree of flatness of the reticle using the first sensor comprises:
emitting an optical signal at a predetermined angle toward a top surface of the reticle; and
sensing the optical signal reflected from the top surface of the reticle using a light receiving unit.

16. The method of claim 14, wherein the flattening of the reticle comprises:
inputting the degree of flatness of the reticle sensed by the first sensor to a control unit; and
moving the first reticle support units' cylinders using a signal processed by the control unit.

17. The method of claim 16, further comprising measuring pressures applied to the cylinders and displacements of the cylinders using second sensors.

18. The method of claim 14, wherein the cylinders are disposed under at least both sides of the reticle and are independently moveable to vertically move the reticle corresponding to the degree of flatness of the reticle sensed by the first sensor.

19. An apparatus to hold a reticle, comprising:
a reticle stage having a first and a second side;
moveable cylinders disposed in both the first and second sides to support the reticle;
a sensor to sense the flatness of the reticle; and
a control unit responsive to the sensor to move the moveable cylinders.

20. The apparatus of claim 19, wherein the moveable cylinders are configured to move substantially vertically.

21. The apparatus of claim 19, further comprising a flexible pad placed on two or more of the cylinders.

22. The apparatus of claim 19, wherein the cylinders comprise vacuum holes disposed therein to securely hold the reticle.
